(19) United States
(12) Patent Application Publication
(10) Pub. No.: US 2008/0228852 A1
(43) Pub. Date: Sep. 18, 2008

(54) Synchronization of Information Items with References

(75) Inventors: Knut Eilif Husa, Sande (NO); Geir Melby, Heggedal (NO); Hong Nhung Thi Vo, Askim (NO)

Correspondence Address: ERICSSON INC., 6300 LEGACY DRIVE, M/S EVR 1-C-11, PLANO, TX, 75024, US

(73) Assignee: Telefonaktiebolaget LM Ericsson (publ), Stockholm (SE)

(21) Appl. No.: 11/916,690

(22) PCT Filed: Jan. 16, 2006
(86) PCT No.: PCT/NO06/00022

§ 371 Date: Dec. 6, 2007

(30) Foreign Application Priority Data
Jun. 6, 2005 (NO) 20052719

(51) Int. Cl. G06F 15/16

(52) U.S. Cl. 709/201

(57) ABSTRACT

The present invention is related to a method and a system for bidirectional synchronisation of information between two devices, a first device and a second device where the synchronisation is limited to exchange of modified data and the request for synchronization can be initiated by any of the two devices. The synchronisation is of an incremental type adapted to synchronize items making references/couplings to other items.

### TECHNICAL FIELD

The present invention relates to synchronization of information between clients and servers, more particularly so to a system and a method for bidirectional synchronisation of information between two devices, a first device and a second device where the synchronisation is limited to exchange of modified data and the request for synchronization can be initiated by any of the two devices.

### BACKGROUND ART

In today's mobile telephone applications different kinds of information may be stored and manipulated. Examples of this are pictures, music, video, calendar information and contact registers. It is also the case that information can be coupled by relating different information entities to each other. A typical example of the latter is by relating contacts from the contact register to a meeting because they are going to participate to that meeting. Further it is known to relate pictures to phone numbers or to relate a particular melody to one or more particular numbers.

Synchronization is the process of keeping information residing in different system consistent that is to update information there between. Synchronization of information on mobile devices, or any other device is performed due to a number of reasons:

Keeps Each System with Information that is up to Date
Systems with distributed information can consist of multiple sites, each holding a local copy of the data required at that site. Synchronization technologies can exchange information among the sites, keeping them all up to date with correct data.

Reduces Network Data Flow
By accessing the local synchronized data instead of always accessing a central server, the flow of data on the network can be considerably reduced. Requests can be made to a local server that can respond with its local synchronized and updated data.

Faster Response Time
When accessing local data instead of server data, the response time will also be much faster. Traffic, network failure, servers down may be reasons of network latency. With local access, the users do not depend on servers to be able to access data.

Reliable Data
Although mobile devices are not always connected to the network, it is still assumed that they contain the latest correct information retrieved through a last successful synchronization with another device.

There exist a number of synchronization protocols today. The most common ones are:

Palm HotSync Protocol
IntelliSync
Active Sync
SyncML

### DISCLOSURE OF THE INVENTION

### Technical Problem

When synchronizing information with references on a mobile device, e.g. meetings that have references to contact items, only calendar information (meeting information) is handled and not the contact registers. In other words if an item within a first category is updated and this item makes reference to further updated other categories, then when synchronizing the first category no synchronization will be carried out with respect to the other categories unless explicitly requested by a user.

This might cause consistency problems on a synchronization server because the meeting will have open references to contacts that are not present on the server. Other cases where this problem might occur are by coupling images and sound, video and text, contacts and pictures, etc.

One may avoid the problems by performing a full synchronization of all categories one at a time where all the data items in one device that is to be synchronized with another device are compared with each other field-by-field (category to category). However this solution is time-consuming as long as all of the databases that have been set up for synchronisation must be synchronised, hence generating a lot of unnecessary data traffic.

### Technical Solution

Thus there is a need to check whether synchronization must be performed on other information entities than explicitly requested as a result of synchronizing an information entity with references. The decision to synchronize related information entities or not will be taken based on their status (new, updated or deleted).

### ADVANTAGEOUS EFFECTS

The advantages of the invention are quite obvious. If there exist references between different item types on a client device prior to synchronization, the references will be maintained on the synchronization server after synchronization has been performed, e.g. both the calendar item and its related participants has been synchronized and are present on the synchronization server.

Further, traffic will be reduced as long as there rarely will be any need to perform a full synchronization, where all the databases that are set up for synchronisation is synchronised, between two or more devices.

### SUMMARY OF THE INVENTION

Other advantageous effects will be apparent by the accompanying dependent claims and particularly so by a method for bidirectional synchronisation of information between two devices, a first device and a second device where the synchronisation is limited to exchange of modified data and the request for synchronization can be initiated by any of the two devices where the method comprises the steps of:
a) sending a initialization message/package from the first device to the second device,
b) responding by sending a initialization message/package from the second device to the first device,
c) sending one or more synchronization messages/packages from the first device to the second device,
d) analyzing at the second device the synchronisation message(s)/package(s), and
e) simultaneously or substantially simultaneously as in d perform a reference test checking if items contained in the synchronisation message(s)/package(s) makes reference to other items.

### BRIEF DESCRIPTION OF THE DRAWINGS

In the following is a short description of the drawings accompanying the present invention.

FIG. 1: Synchronization example with mobile phone and server,

FIG. 2: MSC of synchronization initialization [OMA SyncML],

FIG. 3: MSC of two-way sync [OMA SyncML],

FIG. 4: Client device with Calendar item related to Contact item,

FIG. 5: State of client device and server prior to synchronization,

FIG. 6: State of client device and server after synchronization,

FIG. 7: Calendar item with reference to a contact that has been updated on the server,

FIG. 8: Situation picture when first synchronization round/step is finished,

FIG. 9: State of client device and server after final synchronization round/step, and

FIG. 10: Flow diagram for synchronization of items with relations

### MODE(S) FOR CARRYING OUT THE INVENTION

In the following a detailed description of the present invention will be disclosed with reference to the accompanying drawings.

The drawings are included herewith so as to ease the understanding of the present invention and they are not intended to define the scope of the protection for the present invention.

Wherever in the following where the wording mobile phone is used it is to be understood that mobile phone can be substituted with any device adapted to synchronize information stored internally with another device having the same capabilities.

Such devices can be any of the following: a mobile telephone, a smartphone, a PDA, a laptop computer, a computer, a MP-3 player, or a multimedia player.

Wherever in the following where the wording server is used it is to be understood that server can be substituted with any device adapted to synchronize information with another device having the same capabilities. The use of server is merely intended to ease the readability of the specification.

A server can be any computer, being handheld, a desktop, a laptop, a traditional network server an application server or even devices considered to be peripherals.

The use of the client server terminology is used so as to ease readability, and the generic principle of the invention disclosed herewith should not be affected by this use.

This invention disclosure will be targeted towards the SyncML protocol as it is the most open and commonly used synchronization protocol on mobile devices. However, the invention has a generic approach and will be applicable for other synchronization protocols as well.

In the following are embodiments of equal value disclosed by way of example.

### A MODE FOR CARRYING OUT THE INVENTION USING SYNCML

There are two roles within a SyncML synchronization system, as shown in and further explained in the sections underneath.

A SyncML Client contains a sync client agent that sends first its modifications to a SyncML server. It must be able to receive responses from server. This is typically a mobile phone, PC, PDA or another device adapted to initiate synchronisation. In a grid network with many nodes maintaining consistent data, a node could be a combined client and server responding to nodes as a server and requesting data from nodes as a server. In such setting the client could also typically be a sensor device.

The present invention does not target any specific synchronization protocol but for convenience we bring a short overview of the SyncML protocol in this section.

The SyncML specification [OMA SyncML] defines seven different sync types. These are listed below in Table 1.

TABLE 1

| Sync scenario | Description |
|---|---|
| Two-way sync | Both the client and the server exchange information |
| (fast sync) | about modified data in these devices. The client is the |
| | one to send the modifications first. |
| Slow sync | This is a kind of two-way sync where all the data |
| | items are compared with each other field-by-field. The |
| | client sends all its data to the server that processes |
| | the sync analysis for the two data sets. |
| One-way sync | The client sends its modifications to the server, but |
| from client only | the server does not send its own back to the client. |
| Refresh sync | The client sends all its data to the server that replaces |
| from client only | all data in the target database with the new received |
| | data. |
| One-way sync | The server sends its modifications to the client, but |
| from server only | the client does not send its own back to the server. |
| Refresh sync | The server sends all its data to the client that replaces |
| from server only | all data in the target database with the new received |
| | data. |
| Server alerted | The server alerts the client to perform sync. The |
| sync | server then informs the client to start a specific type of |
| | sync with the server. |

Table 1: SyncML sync types

Synchronization Phases

Synchronization runs through two phases [OMA SyncML]:

1. Sync initialization

2. Synchronization

Sync Initialization

Sync initialization has three purposes [OMA SyncML]:
To process the authentication between the client and the server on the SyncML level.
To indicate which databases that are desired to be synchronized and which protocol type that is to be used.
To enable the exchange of service and device capabilities.

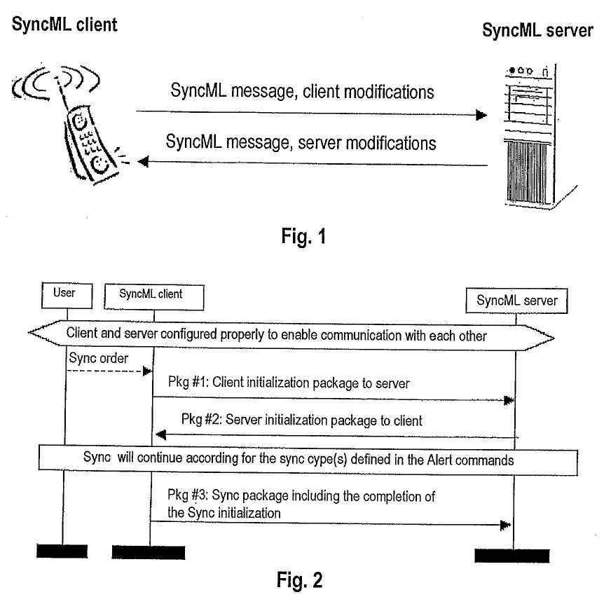

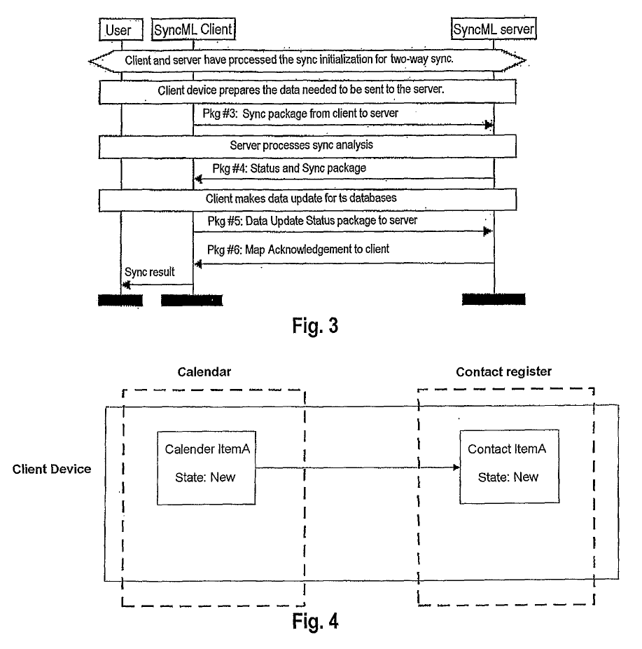

FIG. 2 shows the initialization procedure. Parts of the procedure can be included in the actual synchronization messages if necessary. All the arrows represent SyncML packages, which can include one or more messages. The Alert commands is a message from the server that tells the client what type of synchronization (see Table 1) that is to be initiated. This command is included in Pkg#2, as described in table 2 and in FIG. 1.

Synchronization

This is the phase when the synchronization procedure is carried out. Two-way sync (fast sync i.e. incremental synchronisation) is a normal synchronization type in which the client and the server are required to exchange information about modified data in these devices. For this type of synchronisation the client is always the device that first sends the modifications. According to the information from the client, the server processes the synchronization request, and the data from the client is compared and unified with the data in the server. Then, the server sends its modified data to the client device, which is then able to update its database with the data from the server. shows the sequence of a client-initiated two-way synchronization, and table 2 explains the packages sent.

Table 2: Description of the Sync Packages

TABLE 2

| Pkg # | Description |
|---|---|
| 3 | The client informs the server about all client data modifications which |
| | have happened since the previous sync package with modifications has |
| | been sent from the client to server. Any client modification, which is |
| | done after sending this package, must be reported to the server during |
| | the next sync session. It is not allowed to put them inside subsequent |
| | packages from the client to the server. |
| 4 | The sync package to the client has two purposes: |
| | 1. To inform the client about the results of sync analysis. |
| | 2. To inform about all data modifications, which have happened |
| | in the server since the previous time when the server has |
| | sent the modifications to the client. |
| | Any server modifications, which are done after sending this package, |
| | must be reported to the client during the next sync session. It is not |
| | allowed to put them inside subsequent packages from the server to the client. |
| 5 | This package is needed to transport the information about the result of |
| | the data update on the client side. In addition, it is used to indicate the |
| | LUID's of the new data items, which have been added in the client, i.e. the |
| | Map operation for mapping LUID's and temporary GUID's is sent to the server. |
| | This package may not be sent if the server has indicated that it does not |
| | require a response to its last package to the client. If the client decides |
| | not to send this message, it must be able to cache the Map operations |
| | until the next synchronization is performed. However, the client is |
| | always allowed to send this Data Update Status package to the server, |
| | even if the server has not requested a response. |
| 6 | This package from the server to the client is needed to inform the client that |
| | the server has received the mapping information of the data items. This |
| | acknowledgement is sent back to the client even if there were no Map operations |
| | in last package from the client to the server. |

Other sync types described in table 1 are also possible after the initialization phase, but two-way sync is the most common synchronization procedure, and hence used for exemplification herein.

A typical scenario that discloses the advantages achieved by the present invention is given in the following.

### An Exemplified Embodiment

In this exemplified embodiment we will look into the process of synchronizing information entities that holds references to other entities.

FIG. 4 shows a situation with a client device containing a calendar and contact register. There is a reference from the Calendar item A to the Contact Item A.

If we bring the synchronization server into the picture we see in FIG. 5 that it contains neither of the items prior to synchronization.

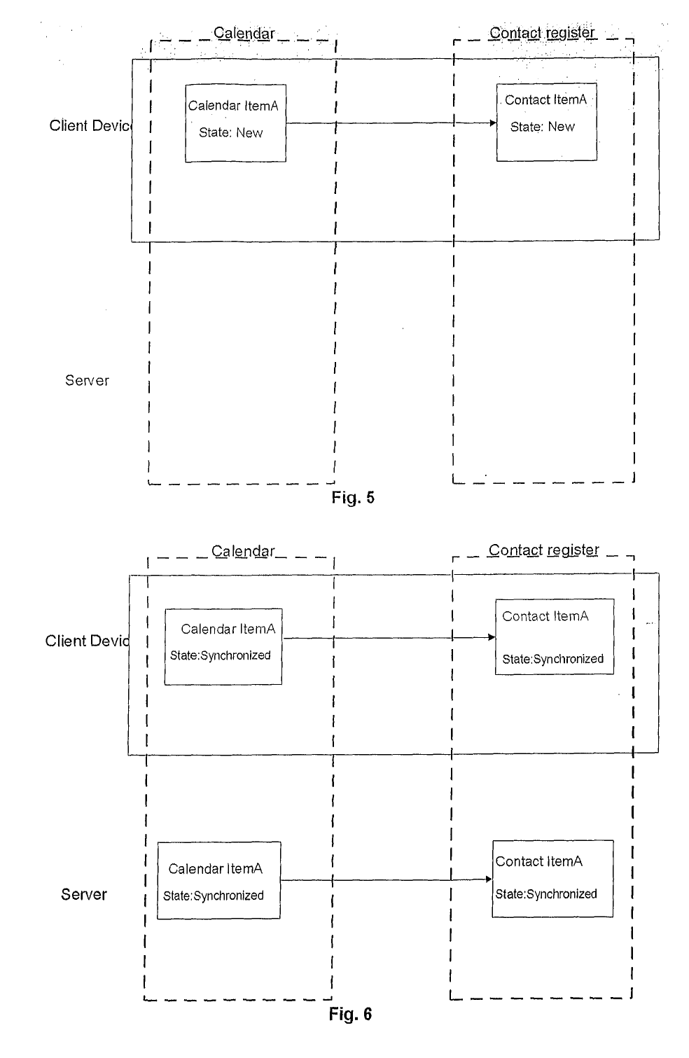

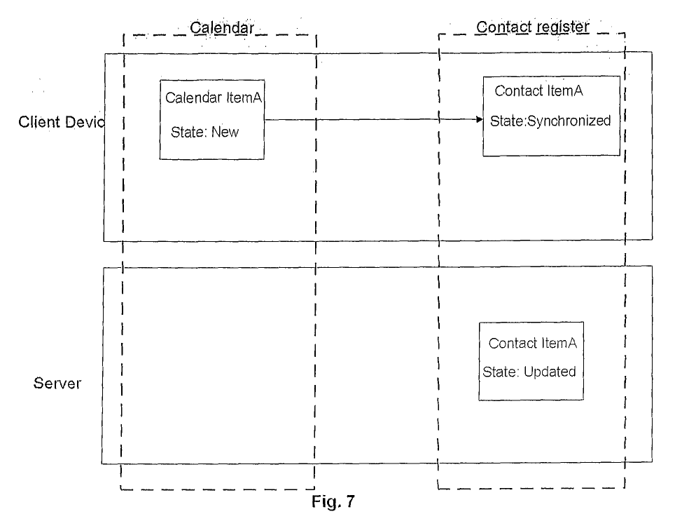

FIG. 6 shows the situation after synchronization using e.g. the SyncML protocol described in a previous section resulting in the situation that the calendar item and contact item resides in both places with a correct reference. Other synchronisation protocols reveal the same result.

### Another Exemplified Embodiment

In this embodiment a use case disclosing synchronisation of related information on both client and server side is shown.

We will examine the situation when an information item has a reference to an element that has been updated on the server.

FIG. 7 shows a situation picture where there exists a calendar item on the client device that has a reference to a contact. The contact also resides in the server, but there in an updated version.

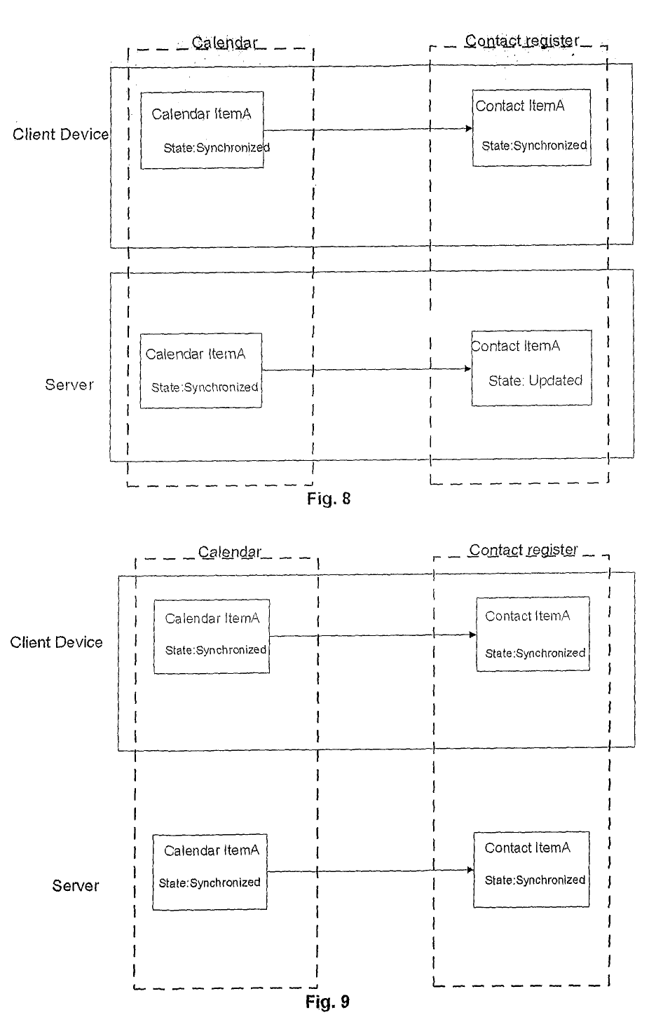

In this case the synchronization process will take place in two rounds/steps. In the first round/step, the client will take initiative to synchronize the calendar item. The situation will then be as depicted in FIG. 8. However, the calendar item will now have a reference to a contact item that is updated on the server. The server will then in the second round/step take initiative to update the contact item on the client device. The situation will finally be as shown in FIG. 9.

### Yet Another Exemplified Embodiment

A first person is invited to a meeting with another person or with other persons; the first person is carrying with him a mobile telephone adapted for PIM synchronization. At the end of the meeting the participants agrees to have a videoconference as a follow up of the present meeting. Contact information is chaired among the participants. The first person is responsible to initiate the scheduled videoconference, thus he adds the time and date of the upcoming videoconference on his mobile telephone, further he is adding updated contact information regarding the participants going to participate in the scheduled conference. One of the parties invited to the videoconference has changed the phone number to his video conference facilities, thus the first person is particularly taking care to notice the new phone number into his mobile phone.

Back at his office the first person is performing a calendar synchronisation with his personal computer, so as to update the upcoming meeting schedules.

At the time of the scheduled videoconference all the participants are invited by being called by the first person; however it is impossible to get in touch with the participant having changed his phone number.

The present invention is overcoming such problems as the one indicated above by its feature of a smart two-way sync (fast sync, incremental sync). Using the smart two-way sync according to the present invention will result in that all items that makes cross-references to other categories of items not explicitly requested to be synchronized will be synchronised provided the cross-referenced item has been updated since the last time this category of items where updated. In other words in this particular case the new phone number would have been added to the first persons computer thus avoiding the embarrassing situation of not calling all invited participants to the videoconference.

In this example the first person is carrying with him a mobile phone, however any device adapted for synchronisation with another device could have served as an example.

### Yet Another Exemplified Embodiment

According to the invention there are two possible scenarios when synchronisation of referenced items occur, the first includes updating a synchronisation anchor the second does not. A synchronisation anchor is used as a time stamp for a last update of a database with items/categories such as calendars, contacts etc. The first method is characterised in that when one or more referred items are to be synchronized, one will synchronise a whole database associated with information items with one or more references, hence one can update the synchronization anchor associated with the whole database associated with the one or more referred items.

Alternatively one can update said one or more referred items, and set the present time stamp for the synchronization anchor to a time stamp equal to a time stamp associated with a previous full synchronization of the associated database, or one can in the latter alternative leave the synchronization anchor “untouched”.

Synchronization Decision Algorithm

The SyncML protocol describes the message sequences performed during the synchronization process. The present invention does not deal with the SyncML protocol as such but rather the decisions that must be carried out on the client and server to decide which items that needs to be synchronized.

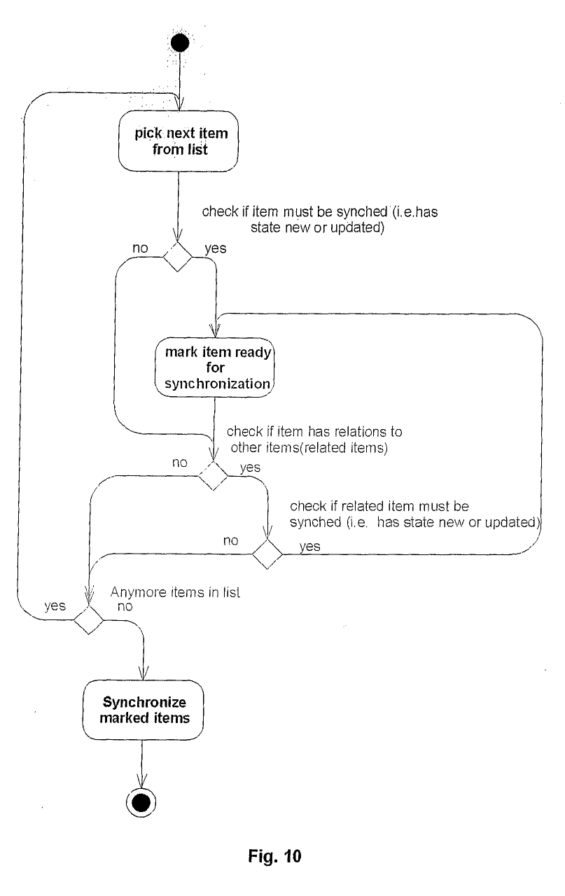

In order to decide which items that must be synchronized to maintain updated references an algorithm has been developed. A flow diagram for the synchronization process is shown in FIG. 10. The starting point for the algorithm will be a list of items that are ready for synchronization, e.g. a contact register containing contact items or a calendar containing meeting items.
SyncML Synchronisation Markup Language
LUID Local Unique Identifier. Every device has a LUID as an identifier for an item.
GUID Global Unique Identifier. The server has a GUID as an identifier for an item. To each device there are a mapping between LUID and GUID.

### REFERENCES

OMA SyncML Common Specification, http://www.openmobilealliance.org/release_program/SyncML_v12.html
Hong Nhung Thi Vo, Synchronization of mobile clients with server applications, Master thesis, NTNU, 2005

1. A method for selection of which items to synchronize between two devices, a first device and a second device where the first device and the second device are ready for synchronization, comprising the steps of:
a) sending a initialization message/package from the first device to the second device,
b) responding by sending a initialization message/package from the second device to the first device,
c) sending one or more synchronization messages/packages from the first device to the second device, wherein that the method further comprises the steps of:
d) at the second device selecting a first item from a list of items,
i) checking if first item must be synchronized, if first item must be synchronized mark this item,
ii) simultaneously or substantially simultaneously as in i perform a reference test, checking if first item makes reference to other items, if the first item makes reference to other items then checking if other item must be synchronized, if the other item must be synchronized mark this item,
iii) checking if there are more item in the list of items, if there are more items in the list of items, select a second item from the list of items and execute similar steps as steps i-iii until the last item in the list of item, and
e) synchronize marked items.

2. The method according to claim 1, wherein that the method further comprises the steps of:
f) sending one or more synchronization messages/packages from the second device to the first device, including results of the synchronization analysis at the second device,
g) analyzing at the first device the synchronization message(s)/package(s), and
h) simultaneously or substantially simultaneously as in g perform a reference test, checking if items contained in the synchronization message(s)/package(s) received from the second device makes reference to other items

3. The method according to claim 2, wherein that step h further comprises the step of simultaneously or substantially simultaneously after the reference test check if items making references to other items must be synchronized.

4. The method according to claim 2, wherein that the method further comprises the steps of:
i) sending a data update message/package from the first device to the second device (including results of the synchronization analysis at the first device).

5. The method according to claim 4, wherein that step i further comprises the act of providing the second device with LUID(s) of new items added in the first device and to provide the second device with temporary GUID(s) sent from the first device.

6. The method according to claim 1, wherein that the method further comprises the step of sending an acknowledge message/package from the second device to the first device.

7. The method according to claim 1, wherein that when one or more referred items are to be synchronized, synchronizing a whole database associated with the one or more referred items.

8. The method according to claim 7, wherein updating a synchronization anchor associated with the whole database associated with the one or more referred items.

9. The method according to claim 1, wherein the steps of:
updating said one or more referred items, and
setting present time stamp for the synchronization anchor to a time stamp associated with a previous full synchronization of the associated database.

10. The method according to claim 1 wherein that execution of the reference test includes conditional testing of referenced items.

11. The method according to claim 10, wherein that the status revealed by the conditional test can be any of the following:
new, updated or deleted.

12. A system for selection of which items to synchronize between two devices, a first device and a second device where the first device and the second device are ready for synchronization where;
i) the first device is adapted to send a initialization message/package from the first device to the second device,
ii) the second device is adapted to respond by sending a initialization message/package from the second device to the first device,
iii) the first device is adapted to send one or more synchronization messages/packages from the first device to the second device,
wherein that the system further comprises:
iv) the second device comprises an analyzing means adapted to select a first item from a list of items,
a) means adapted to check if the first item must be synchronized, if the first item must be synchronized mark this item,
b) a means adapted to simultaneously or substantially simultaneously as in a perform a reference test, so as to check if the first item makes reference to other items, if the first item makes reference to other items then checking if other item must be synchronized, if the other item must be synchronized mark this item,
c) a means adapted to check if there are more item in the list of items, if there are more items in the list of items, the second device comprises an analyzing means adapted to select a next item from a list of items, and thereafter return to a until the last item in the list of Item, and
v) means adapted to synchronize tile marked items.

13. The system according to claim 12, wherein that the system further comprises:
means adapted to send a data update message/package from the first device to the second device including results of the synchronization analysis at the first device.

14. The system according to claim 12, wherein that the system further comprises means for sending an acknowledge message/package from the second device to the first device.

15. The system according to claim 12, wherein that the first device is a client and the second device is a server.

16. The system according to claim 15, wherein that the client can be any of the following:
a mobile telephone,
a smartphone
a PDA,
a laptop computer,
a computer,
a MP-3 player, or
a multimedia player.
